(19) United States
(12) Patent Application Publication
(10) Pub. No.: US 2020/0139305 A1
(43) Pub. Date: May 7, 2020

(54) Filter For Separating Hydrophilic And Hydrophobic Fluids And Method For The Production Thereof

(71) Applicant: HWK-Kronbichler GmbH, Ebbs (AT)

(72) Inventors: Benjamin NAIER, Innsbruck (AT); Herwig SCHOTTENBERGER, Patsch (AT); Rania BAKRY, Innsbruck (AT); Gabriel PARTL, Fliess (AT)

(73) Assignee: HWK-Kronbichler GmbH, Ebbs (AT)

(21) Appl. No.: 16/609,497

(22) PCT Filed: May 17, 2018
(86) PCT No.: PCT/EP2018/062965

§ 371 Date: Oct. 30, 2019

(30) Foreign Application Priority Data
May 18, 2017 (EP) 17171765.5

(51) Int. Cl. B01D 69/02; B01D 69/12; B01D 67/00; B01D 71/28

(52) U.S. Cl. CPC B01D 69/02; B01D 69/125; B01D 67/0006; B01D 71/28; B01D 2323/345; B01D 2325/16; B01D 2325/36; B01D 2323/22; B01D 2323/30; B01D 2325/02

(57) ABSTRACT

The invention relates to a filter for separating hydrophilic from hydrophobic fluids, wherein the filter comprises an oleophobic polymer, consists thereof or is coated therewith, and wherein the filter exhibits hydrophilic and oleophobic properties, wherein at least some of the repetitive units of the oleophobic polymer can be traced back to a fluorine-containing monomer which is an ionic organic molecule that has an ionic group, a cross-linkable group and a fluorine-containing group. The invention further relates to a method for producing such a filter and to a method for separating hydrophilic and hydrophobic fluids by using such a filter.

The invention relates to a filter for separating hydrophilic and hydrophobic fluids, wherein the filter comprises, consists of, or is coated with an oleophobic polymer and wherein the filter exhibits hydrophilic and oleophobic properties. The invention furthermore relates to a method of producing such a filter.

Hydrophilic and hydrophobic fluids such as water and oil are currently typically separated from one another on an industrial scale with the aid of water separators. Such apparatus are as a rule large, expensive, and not very mobile.

Filter membranes having hydrophilic and oleophobic coatings are furthermore known from the prior art with which a separation of water and oil can likewise take place. However, problems are often associated with the technical solutions.

U.S. Pat. No. 3,567,500 describes the use of hydrophilic and oleophobic materials on the basis of fluoroamide-amino polymers. According to the knowledge of the inventors of the present patent application, these solution approaches were, however, presumably not successful due to high production costs.

US 2015/136712 A1 discloses a composition comprising a hydrophilic and oleophobic copolymer composed of an uncharged fluoro(meth)acrylate and of a betaine not containing fluorine as comonomers. Membranes are furthermore described that have a coating of such a polymer to be able to separate water and oil from one another. The linear fluorine chains can be mixed with a membrane solution or applied directly and can thus be considered for upgrading existing filters. The long-chain fluoroacrylates, however, have limited solubility and the implementation requires the use of fluorine solvents that are frequently expensive and toxic. The synthesis of these polymers also requires the use of environmentally harmful surfactants. A further disadvantage comprises the fact that the separation performance depends to a great extent on the chain length of the perfluoroalkyl groups on the use of fluoroacrylates. Due to legal requirements, only perfluoroalkyl chain lengths of a maximum of C₆F₁₃ may now be used in Europe and in the US, with an oleophobic effect only being possible to a limited degree with these known polymers and copolymers with these lengths of fluorine side chains.

U.S. Pat. No. 9,186,631 B2 discloses a hydrophilic membrane having a contact angle for water of less than 5° and having a contact angle for oil of more than 90° C. This membrane consists of a polyethylene diacrylate, 1H,1H,2H,2H-heptadecafluorodecyl polyhedral oligomeric silsesquioxane (F-POSS) and 2-hydroxy-2-methyl propiophenone. The membrane is mechanically stable due to the cross-linkers and the technical coefficients are satisfactory. However, a perfluoroalkyl chain length of C₈F₁₇ is again used and the options for use are therefore limited due to said legal regulations. In addition, polyhedral oligomeric siloxanes represent a very expensive substance class. A further disadvantage comprises the fact that the membrane does not include any ionic structural portions, that is, also has no charge, and is thus susceptible to microbial growth.

US 2014/0048478 A1 describes a coating for a membrane that includes hydrophilic ethylene glycol segments and oleophobic vinylidene fluoride segments and has a contact angle for water of 0 to 60° and a contact angle for oil of 40° to 100° by a combination of these segments. It is disadvantageous with this technology that the different membrane segments are often not miscible with one another or are only miscible with one another in a limited manner. In addition, no charged monomers or polymers can be used. This has the result that the membranes are susceptible to possible contamination. A cross-linked structure can also only be achieved in a very complex and/or expensive manner using these membranes.

WO 2015/075446 A2 discloses the use of a dip-coating process for filters in which charged polymers not containing fluorine and surfactants containing fluorine are alternately applied. It must be noted as disadvantageous here that the fluorosurfactants only adhere to one another due to electrostatic interactions. The coating is therefore easy to wash off and is only durable for a brief period. There is also the risk that fluorosurfactants are emitted to the environment.

US 2005/0287111 A1 discloses the use of cationic fluorosurfactants in polymeric systems and shows their applications in the most varied areas. However, it has previously been assumed for the provision of hydrophilic and oleophobic membranes having charged fluorosurfactants that a movable fluorine group has to exist. Reference must e.g. be made in this connection to “Recent advances in oil-repellent surfaces”, International Materials Reviews, 61:2, 101-126, 2016, “Surface and solid-state properties of a fluorinated polyelectrolyte-surfactant complex”, Langmuir, 1999, 15, 4867-4874, and “Nano-structured materials with low surface energies formed by polyelectrolytes and fluorinated amphiphiles (PEFA)”, Polym. Int., 2000, 49, 636-644).

It is the object of the invention to provide a hydrophilic and oleophobic filter that can be produced simply and inexpensively and that exhibits exceptional properties in the separation of hydrophobic fluids.

Against this background, the invention relates to filters simultaneously having hydrophilic and oleophobic properties that comprise, consist or, or are coated with an oleophobic polymer. In accordance with the invention, at least some of the repetitive units of the oleophobic polymer are based on a monomer that contains fluorine and that is an ionic organic molecule that therefore has an ionic group, a crosslinkable group, and a group containing fluorine in a covalent bond. Due to the simultaneous hydrophilic and oleophobic properties, the filter in accordance with the invention can, for example, be used in the separation of water and oil phases of an emulsion. The water phase can here pass through the filter while the oil phase is retained. The filter in accordance with the invention can furthermore also be used in the separation of gases or in the separation of gases and liquids having different polarities.

The filter can be a fluid-permeable body, and preferably a layer-shaped body, e.g. a filter membrane, or a fluid-permeable bulk material, and preferably an encapsulated bulk material. The filter can comprise a substrate such as a membrane that is covered at least in part by a coating comprising or consisting of the oleophobic polymer. Examples for suitable substrates include textile materials such as nonwovens or fabrics of organic or inorganic fibers (e.g. silk, cotton, lyocell, polyamide, or the like), paper, metal meshes (e.g. of stainless steel or bronze), plastic membranes, or porous metal bodies or ceramic bodies such as glass frits. Organic fibers, for example, include polyolefin fibers. Porous metal bodies or ceramic bodies, for example, include sintered bodies.

Examples of suitable coatable materials for plastic membranes include polyurethane, PVDF (polyvinylidene difluoride), PTFE (polytetrafluoroethylene), expanded PTFE, PSF (polysulfone), polyethersulfone, PAN (polyacrylonitrile), polypropylene, polyethylene, polyamide, polystyrene, polyethylene, metal meshes, cellulose-based materials, and combinations thereof.

In accordance with the invention, the filter comprises the oleophobic and partially fluorinated polymer containing ions, is completely produced thereof, or is at least sectionally coated therewith. A granular material of a bulk product, the fibers of a nonwoven, stitched fibers, or a plastic membrane can be made from the described polymer. Furthermore, granular materials of a bulk product or each of the above-named filter bodies can be at least sectionally coated with the described oleophobic, partially fluorinated polymer containing ions.

If the filter is a porous body such as a porous membrane, the average pore size for achieving an optimum separation effect between water and oil phases can comprise, for example, between 0.001 and 1000 μm, and preferably between 0.01 and 500 μm.

In an embodiment, the group containing fluorine is a perfluorinated hydrocarbon group. A perfluorinated hydrocarbon group is to be understood as a hydrocarbon group in which all the hydrogen atoms have been replaced with fluorine atoms. In an embodiment, the functional group containing fluorine is a group of the type —(CF₂)ₙ—F, where n is between 1 and 20 and is preferably 5, 6, or 7. The chain length of 5 to 7 is particularly advantageous since the oleophobic properties are already very highly pronounced with this chain length, but good environmental compatibility is simultaneously also present. The use of a perfluorohexyl group having the structural formula (CF₂)₆—F is particularly preferred. Alternatively, fluoroethers are also conceivable as groups containing fluorine. They are preferably of the type (CF₂)ₙ—O—(CF₂)ₘ, where n and m can be between 1 and 6 independently of one another. Alternatively, fluorinated benzene derivatives are also conceivable, with 2 to 5 fluorine atoms or trifluoromethyl groups being able to be bonded to aromatic compounds.

In an embodiment, the crosslinkable group comprises a reactive double bond. A C═C double bond such as in particular a substituted or unsubstituted vinyl group is preferred here. Allyl groups, (meth)acrylate groups, or (meth)acrylamide groups are furthermore suitable in an embodiment.

In an embodiment, the crosslinkable group comprises an isocyanate, an anhydride, an amine, an acid group, an azide, a diazonium salt, or a hydroxyl group.

The crosslinkable group is reacted in the oleophobic polymer of the filter in accordance with the invention and forms a part of the covalent link between adjacent repetitive units. An unsubstituted vinyl group of the monomer containing fluorine has the incorporated partial structure of a double-bond ethylene group in the polymer, for example

In an embodiment, the ionic group is an ionic heterocyclic group, and in particular a heteroaromatic group.

In an embodiment, the charge is delocalized over a plurality of atoms of the ionic group.

In an embodiment, the ionic group or the monomer containing fluorine is positively charged overall. Provision can, for example, be made that the ionic group or the monomer containing fluorine is simply positively charged overall.

In an embodiment, the ionic group is an ionic heterocyclic group, and in particular a heteroaromatic group having at least one ring-forming nitrogen atom that adopts a positive charge by additional substitution. Examples include an N,N-disubstituted imidazolium group, an N,N-disubstituted benzimidazolium group, an N-substituted vinyl pyridinium group, or a quaternary ammonium compound. N-alkylated groups such as N,N-dialkylated imidazolium groups are particularly preferred.

The substitutes at the nitrogen atom can, for example, be the crosslinkable or fluorinated group that is bonded to the nitrogen atom directly or indirectly, i.e. using a spacer, preferably an aliphatic spacer, disposed therebetween.

In an embodiment, the ionic group is arranged between the crosslinkable group and the group containing fluorine. The structure of the monomer containing fluorine is preferably such that the crosslinkable group and the group containing fluorine are arranged radially starting from the ionic group and preferably from the ionic heterocycle.

In an embodiment, a spacer is arranged between the ionic group and the group containing fluorine and/or between the ionic group and the crosslinkable group. The group containing fluorine or the crosslinkable group is therefore covalently bonded to the ionic group using an interposed spacer in this embodiment. Suitable spacers include uncharged and non-fluorinated organyl groups. Preferred examples preferably include linear alkylene groups having 1 to 10 carbon atoms and preferably 1 to 5 carbon atoms, further preferably having 1, 2, or 3 carbon atoms. Ethylene is particularly preferred.

In an embodiment, the spacer includes an ether bridge (—O—) or a thioether bridge (—S—). The group containing fluorine can, for example, be bonded to the spacer via an ether bridge. The spacer can, for example, be bonded to the ionic group via a thioether group.

In an embodiment, the monomer containing fluorine has between 8 and 50 heavy atoms, and preferably between 10 and 30 heavy atoms. A heavy atom is understood as all atoms except for hydrogen in the present case.

In an embodiment, the molar mass of the monomer containing fluorine is between 100 and 3500 g/mol, preferably between 130 and 1000 g/mol.

In an embodiment, the monomer containing fluorine is an ionic fluid.

In an embodiment, the monomer containing fluorine comprises exactly one ionic and crosslinkable group containing fluorine.

In an embodiment, the monomer containing fluorine can also have a plurality of ionic groups and/or a plurality of groups containing fluorine and/or crosslinkable groups. The monomer containing fluorine here preferably comprises at least two identical or different centers that each comprise a charged group and preferably also a group containing fluorine. The centers can be connected to one another by means of a linker that preferably connects the ionic groups of the two centers. The linkers can be those groups such as have already been described as spacers above.

In an embodiment, the functionalized monomer has an organosulfanyl group that is preferably additionally substituted and that represents an anionic group.

Suitable cationic monomers containing fluorine, for example, comprise the compounds shown below:

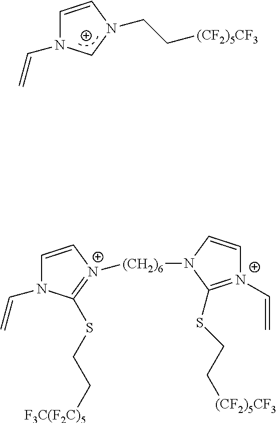

Further suitable monomers containing fluorine include the following molecules:

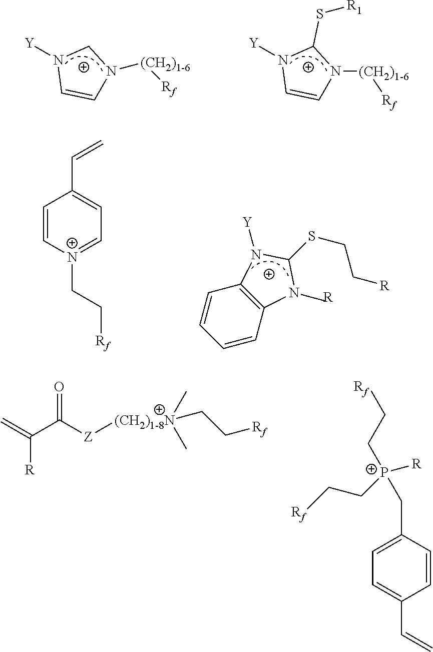

Further suitable anionic monomers containing fluorine include the following molecules:

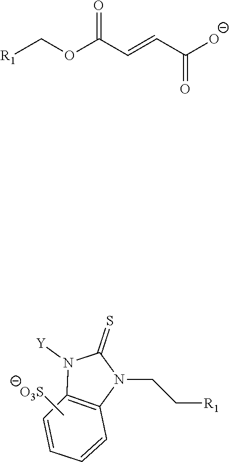

In the formulas shown above, Y stands for a crosslinkable group in accordance with the above definition; R₁ stands for a group containing fluorine in accordance with the above definition; and R stands for a hydrogen or for a C1-6 alkane.

A preparation of these monomers can take place, for example, as described in Partl et al., “3-(1H,1H,2H,2H-Perfluorooctyl)-1-vinyl-4-imidazoline-2-thione”, IUCrData (2017) 2, x170648.

In an embodiment, the oleophobic polymer is a copolymer at least some further portion of the repetitive units are based on a hydrophilic comonomer. The hydrophilic comonomer has a polymerizable group and an ionic or uncharged hydrophilic group. These comonomers can increase the hydrophilia of the copolymer. Charged comonomers of this type can also improve the anti-fouling properties.

The additional comonomer preferably does not have any groups containing fluorine. This is to be preferred for ecological aspects and facilitates the coordination between hydrophilic and oleophobic properties of the coating in the given embodiment.

Examples for hydrophilic comonomers comprises charged or uncharged (meth)acrylate monomers or (meth)acrylamide monomers or (meth)acrylamide monomer derivatives. Suitable examples of uncharged hydrophilic monomers comprise those with ethylene glycol or hydroxyl groups as side chains. Further examples comprise betainic monomers.

Hydrophilic and oleophobic properties of the polymer and thus of the filter can be coordinated with respect to one another by the use of a hydrophilic comonomer. The oleophobic properties of the polymer or of the filter are generally due to the groups containing fluorine of the monomer containing fluorine. The higher the content of monomers containing fluorine is in one of the present embodiments, the more oleophobic or simultaneously also hydrophobic the polymer normally is. The higher the content of the hydrophilic comonomer in the present embodiment, the more hydrophilic the coating becomes. If the proportion of the hydrophilic comonomers becomes too large, however, the simultaneous oleophobic character is lost.

In an embodiment, the proportion of the repetitive units of the copolymer that are due to the monomer containing fluorine is between 0.1 and 50 mol %, preferably between 0.5 and 15 mol %, and further preferably between 1 and 10 mol %. A sufficient technically usable oleophobia is achieved in these ranges and at the same time too high a fluorine concentration is avoided, which is desirable for economic and technical environmental reasons.

In an embodiment, the hydrophilic group is a polar or ionic group, for example an acidic anion. Suitable examples comprise sulfonates or phosphonates.

In addition to the fluorinated monomer and, preferably, to the hydrophilic comonomer, other comonomers can also form the basis of the copolymer; for example, unfunctionalized comonomers with only one crosslinkable group, but no otherwise functionalized group, highly oleophobic monomers with a crosslinkable functional group containing fluorine, but no charged functional group or crosslinking comonomers. Crosslinking comonomers can have at least two crosslinkable groups, but no otherwise functionalized groups. A reactive group can also be present instead of a crosslinkable group to be able to prepare a preferably covalent bond to the surface of the substrate.

Examples of potentially suitable additional comonomers comprise uncharged monomers containing fluorine that are based on (meth)acrylate monomers or (meth)acrylamide monomers containing fluorine. These comonomers can increase the oleophobia of the copolymer. Polymers, oligomers, and prepolymers can preferably also be co-components. They can be based on vinylidene difluoride, tetrafluoroethylene, vinyl fluoride, chlorotrifluoroethylene, ethylene-tetrafluoroethylene, perfluoro(ethylene propylene), and perfluoro alkoxy compounds as well as on combinations thereof as monomers.

Further examples of potentially suitable additional comonomers comprise reactive or latent monomers that are based on reactive or latent (meth)acrylate monomers, (meth)acrylamide monomers, and allyl or vinyl monomers. These monomers can increase the adhesion of the polymer to different substrates. Comonomers can be preferred here that comprise an isocyanate group, a blocked isocyanate group, a polymerizable trialkoxysilyl group, a polymerizable epoxy functionality, or a plurality of double bonds.

Further examples of potentially suitable additional comonomers comprise hydrophobic monomers that are based on hydrophobic (meth)acrylate monomers or (meth)acrylamide monomers. These monomers preferably include a branched or unbranched alkyl group.

Further examples of potentially suitable additional comonomers comprise (meth)acrylic acid and (meth)acrylic acid derivatives, inter alia acrylic acid, methacrylic acid, 3-sulfopropylacrylate, hydroxyethyl(meth)acrylate, lauryl(meth)acrylate, octadecyl(meth)acrylate, stearyl(meth)acrylate, isobornyl(meth)acrylate, (poly)ethyleneglycol(meth)acrylate.

Further examples of suitable additional monomers comprise (meth)acrylamide and (meth)acrylamide derivatives, inter alia 2-acrylamido-2-methylpropane sulfonic acid (AMPS), 2-acrylamido-2-methylpropane sulfonate, N, N-dimethyl aminoethyl acrylamide (DMAEAA), N,N-dimethyl aminopropyl acrylamide (DMAPAA), trimethylammonium ethyl(meth)acrylate chloride, N-hydroxyethyl acrylamide (HEAA), dimethyl acrylamide (DMAA), N-isopropyl acrylamide (NIPAM), diethylacrylamide (DEAA), and N-tert-butyl acrylamide (t-BAA). In addition, urethane acrylate, epoxy acrylate, and derivatives of the epoxy acrylate can be used.

Examples of suitable crosslinkable comonomers include methylenemethylbis(meth)acrylate, ethylenebisethyl(meth)acrylate, bisglycidylmethacrylate, urethanedimethacrylate, hexanedioldimethacrylate, tetraethylene glycol dimethacrylate, (poly)ethylene glycol di(meth)acrylate, glycerin di(meth)acrylate, glycerin tri(meth)acrylate, 1,9-nonanediol di(meth)acrylate, dipentaerythriol hexaacrylate, dipentaerithritol penta-/hexaacrylate, and trimethylol propane ethoxylate triacrylate.

Further examples of potentially suitable additional comonomers include uncharged fluoro(meth)acrylates. Examples include 1H,1H,2H,2H-perfluorooctyl(meth)acrylate, pentafluoropropyl(meth)acrylate, and generally branched and unbranched 1H,1H,2H,2H-perfluoroalkylmethacrylates, and 1-(1H,1H,2H,2H-perfluorooctyl)-3-vinyl-1,3-dihydro-2H-imidazole-2-thione.

Further examples of potentially suitable additional comonomers include uncharged reactive monomers. Examples include glycidyl(meth)acrylate, trimethylvinylsilane, trimethoxyvinylsilane, triethoxyvinylsilane, triacetoxy(vinyl)silane, tris(trimethylsiloxy)(vinyl)silane, 3-(trimethoxysilyl)propylmethacrylate, 3-(trimethoxysilyl)propylacrylate, 3-isopropenyl-α,α-dimethylbenzylisocyanate, 2-isocyanatoethyl(meth)acrylate, 2-[3,5-dimethylpyrazol)carboxyamino]ethyl(meth)-acrylate, 1,1-(bisacryloyloxymethyl)ethylisocyanate, and 2-methyl-2-(2-isocyanato-ethoxy)ethylester. In an embodiment, the above-named isocyanates are protected against reaction with a blocking agent. The blocking agents can be removed again by heat or by catalysts. The durability, the adhesion, and the washing stability can thereby be considerably improved in the preparation. Examples of preferred blocking agents include 2-butanone oxime, 3,5-dimethylpyrazole, ε-caprolactam, di-tert-butylamine, and tert-butylbenzamine.

Provision is made in an embodiment that at least some of the additional monomers have a charge, and preferably comprise salts of the 2-acrylamido-2-methylpropanesulfonic acid, salts of the sulfopropyl(meth)acrylic acid, salts of the (meth)acrylic acid, salts of [2-(methacryloyloxy)ethyl] trimethyl ammonium compounds such as [2-(methacryloyloxy)ethyl]trimethyl ammonium chloride, (vinylbenzyl)benzyltrimethyl ammonium compounds, [3-(meth-acrylamino)propyl]dimethyl(3-sulfopropyl) ammonium hydroxide betaine, diallyldimethyl ammonium compounds, salts of the maleic acid, maleic acid esters, and combinations thereof.

Provision is made in an embodiment that at least some of the additional monomers have an additional functionality that can come into interaction with a substrate and that preferably comprises vinyl silanes, (meth)acrylic silanes, glycidyl(meth)acrylate, isocyano-acrylates, blocked isocyano-acrylates, blocked and non-blocked 3-isopropenyl-α,α-dimethylbenzylisocyanate, and combinations thereof.

Provision is made in an embodiment that at least some of the additional monomers have an additional functionality that is neutral and that preferably comprises styrene, urethane(meth)acrylates, ester(meth)acrylates, polyethylene(meth)acrylates, linear and branched alkyl(meth)acrylates and fluoro(meth)acrylates or combinations thereof.

As an alternative or supplement to crosslinking comonomers, provision can also be made that at least some of the monomers containing fluorine and/or of the hydrophilic comonomers have at least two crosslinkable groups.

The proportion of the repetitive units of the copolymer based on monomers or comonomers having at least two crosslinkable groups can be between 0.1 and 2 mol % in an embodiment.

Within a specific framework, the durability of the polymer and, if used as a coating, its adhesion to a substrate, can be improved by a higher degree of crosslinking.

The crosslinking under certain circumstances also enables the creation of systems that can be recycled. Provision can be made that the monomers having at least two crosslinkable groups comprise two different kinds of crosslinkable groups, with one of these groups including a physically or chemically splittable bond, for example by temperature or by hydrolysis.

The crosslinkable groups of the comonomers can be formed in the same way as has been described in connection with the crosslinkable groups of the monomers containing fluorine.

The copolymer is preferably a random copolymer having randomly distributed repetitive units.

The filter also comprises counterions corresponding to the ionic groups of the fluorinated monomers and optionally of the hydrophilic monomers, which counterions can, for example, be halogenide anions or alkaline metal cations. Examples of suitable anionic counterions comprise chloride, bromide, iodide, aryl sulfonate, alkyl sulfonate, perfluoralkyl sulfonate, alkyl sulfate, sulfate, aryl phosphonate, alkyl phosphonate, monoalkyl phosphate, dialkyl phosphate, (di-)hydrogen phosphate, phosphate, hexafluorophosphate, tetrafluoroborate, hydrogen carbonate, carbonate, carbamate, alkyl carbonate, trifluoromethane sulfonate, bis(trifluormethylsulfonyl)imide, nonaflate, carboxylate, camphor sulfonate, vinyl phosphonate, and combinations thereof.

In addition to the oleophobic and hydrophilic properties for separating aqueous and oily phases, a further advantage of the filters in accordance with the invention is that the ionic groups of the polymer inhibit the formation of a filter-blocking biofilm.

A washing of the filter with water is also possible at all times due to the hydrophilic properties.

In an embodiment, the filter or the polymer portion or the polymer coating of the filter additionally comprises microparticles or nanoparticles beside the oleophobic polymer. They can serve to improve the scratch resistance and/or the hydrophobic and oleophobic properties of a coating resulting from the composition. Conductive particles can likewise be used, for example, to reduce the electrostatic charge or to transport frictional heat away. Examples of suitable nanoparticles comprise silica particles, titanium dioxide particles, aluminum oxide particles, zinc oxide particles, zircon dioxide particles, silver particles, cellulose particles, carbon nanotubes, graphene, carbon particles, polytetrafluoroethylene (PTFE) particles, polyethylene particles, polypropylene particles, and combinations therefrom.

In an embodiment, a filter in accordance with the invention is used for separating hydrophilic and oleophobic components. The presence of pores is essential for the separation performance here. The pore size is preferably 0.001 μm to 1000 μm, preferably 0.005 μm to 500 μm, and particularly preferably 0.01 to 250 μm. The pores of a filter in accordance with the invention can be distributed continuously or discontinuously.

A filter in accordance with the invention is characterized in an embodiment, in that contact angles for water are preferably less than 70°, preferably below 40°, and particularly preferably below 10°. The water can preferably penetrate through the porous structure of the filter. The contact angle for hexadecane or diiodomethane can be above 50°, preferably above 70°, and particularly preferably above 90°. Hydrophobic components preferably do not move through the porous structure.

Against the initially named background, the invention further relates to a method of manufacturing a filter in accordance with the invention, said method comprising the step of providing a solution of the monomer containing fluorine and optionally of the further comonomers, comprising the step of applying this solution to a substrate, and comprising the step of crosslinking the monomers to form the polymer.

The completed filter (for example a completed non-woven, a completed PTFE membrane, or a completed textile) can serve as the substrate, for example. It is equally conceivable that starting materials for producing the filter (for example the fibers to manufacture the non-woven) or the textile (the textile fibers or yarns) serve the production of the filter.

Suitable methods of crosslinking comprise thermal methods, irradiation, chemical hardening, or combinations thereof. For this purpose, UV initiators, thermal radical starters, and/or chemical radical starters such as peroxodisulfate salts are added to the solution. Controlled free radical reactions and reversible deactivating radical polymerizations are also possible. They include atom transfer radical polymerization (ATPR), reversible deactivation polymerization, nitroxide mediated polymerization (NMP), reversible addition fragmentation chain transfer (RAFT) or iodine transfer polymerization (ITP).

In addition, direct radiation hardening methods such as e-beam hardening and polymerizations by means of gamma radiation are also conceivable.

Due to the ionic fluorine monomers, there is particular flexibility in a technical aspect in the manufacture of membranes for separating oil and water.

In an application, the ionic fluoromonomers are applied with possible comonomers, in a dissolved form, in solvents, in a gaseous manner, as ionic liquids or as a eutectic mixture to a porous surface and are directly hardened there.

In an embodiment, pores are generated in a polymer or copolymer in accordance with the invention by porogens and have the result that the polymer or the copolymer matrix can be used directly as the membrane and no substrate is required.

In an application, the ionic fluoromonomers are polymerized with possible comonomers or copolymers in a liquid, preferably water. A polymer dispersion or copolymer dispersion is thereby obtained. The polymer particles obtained in the dispersion in this manner have a particle size distribution of 30 nm to 500 μm, preferably between 50 nm and 50 μm and particularly preferably between 90 nm and 500 nm.

In an embodiment, a described polymer or copolymer in accordance with the invention can be obtained as a solid. This solid can subsequently be dissolved again and a membrane can thereby be obtained. The solvent can here serve as a porogen or additional porogens can be used. The preferred viscosity of the polymer solutions or copolymer solutions for these applications is between 50 mPas and 10,000 mPas, preferably between 100 mPas and 5,000 mPas, and particularly preferably between 200 mPas and 1,000 mPas at 20° C.

The solvent portion of the solution in the method in accordance with the invention can generally amount to between 0 and 99 wt. %, preferably 50 and 99 wt. %, and particularly preferably between 70 and 99 wt. %. The monomer portion of the solution can amount, for example, to between 0.5 and 99 wt. %, preferably 5 to 70 wt. %, particularly preferably 10 to 40 wt. %.

The invention further relates to a method of producing a filter in accordance with the invention that comprises a step of providing a solution of the oleophobic polymer and optionally of further polymer or monomer components, a step of applying this solution to a substrate, and the step of chemical or physical hardening of the polymer solution, preferably a removal of the solvent. The application of the solution can take place within the framework of this method by, for example, spray application or by dip process.

A chemical hardening of the solution of the already crosslinked polymer can, for example, take place by an additional crosslinking of the polymer chains. For this purpose, the procedures and additives described above with the alternative methods are conceivable.

A physical hardening can, for example, take place by simple drying.

The solvent portion of the solution in this method in accordance with the invention can also generally amount, for example, to between 0 and 99 wt. %, preferably between 50 and 99 wt. %, and particularly preferably between 70 and 99 wt. %. The polymer portion of the solution can amount, for example, to between 0.5 and 99 wt. %, preferably 5 to 70 wt. %, and further preferably 10 to 40 wt. %.

A viscosity of 1 mPas to 1,000 mPas, in particular 2 mPas to 500 mPas, and furthermore in particular 3 mPas to 200 mPas at 20° C. is preferred for a spray application or for a dipping process.

The invention therefore comprises spray methods as well as a direct coating by direct polymerization on the most varied substrates.

The invention further relates to a method of producing a filter in accordance with the invention that comprises the step of providing a solution of the oleophobic polymer and optionally further polymer or monomer components, and the step of precipitating or phase extruding with an antisolvent. A fiber or membrane can thus be directly produced from a polymer solution or a copolymer solution by an antisolvent. The polymer solution here preferably has a viscosity of 200 mPas to 50,000 mPas, preferably of 500 mPas to 30,000 mPas, and particularly preferably of 1,000 mPas to 10,000 mPas at 20° C.

In an embodiment, the solvent of both methods in accordance with the invention can be water or a mixture having at least 30 vol. %, and preferably at least 50 vol. % water. Polar solutions such as water, ethanol, or DMF can generally be suitable, with water or a solvent having a water proportion that is as high as possible having to be preferred for ecological and economic aspects. The monomers used within the framework of the present invention are under certain circumstances all soluble in pure water in sufficient concentrations.

It can therefore be stated that the invention comprises in an embodiment the copolymerization of the monomer containing fluorine with at least one hydrophilic comonomer on a permeable substrate.

Generally, preferred methods of the membrane production comprise a thermally induced phase separation, a non-solvent induced phase separation, evaporation-induced phase separation, vapor-induced phase separation, the coating of an existing porous structure, by polymerization, and combinations of these methods.

The invention finally relates to a method of separating hydrophilic and hydrophobic fluids using a filter in accordance with the invention. Filters in accordance with the invention can generally be used to separate watery and oily phases. Exemplary applications comprise water preparation up to the collection of discharged oil after oil catastrophes. A removal of surfactants containing fluorine from wastewater flows can also be achieved using filters in accordance with the invention.

It can be stated in summary that innumerable advantages result with respect to the prior art by the use of charged (ionic) fluoromonomers and of fluoropolymers formed therefrom.

On the one hand, the charge of the monomers enables a much improved solubility in polar solvents. The use of only water or alcohols as solvents is therefore conceivable. This considerably minimizes the emission of volatile organic compounds (VOCs) and results in considerably more environmentally friendly methods. The charged fluoromonomers and fluoropolymers themselves are salts that have a non-measurable vapor pressure and thus no intrinsic liquid.

A further advantage is that charged fluorine groups have a much better anti-fouling behavior than uncharged fluorine groups. Bacterial growth represents one of the greatest problems in membrane technology. This can be managed more efficiently by the present invention.

Fluorosurfactant molecules are grouped in hydrophilic and fluorophilic segments. In addition, due to the ionic structure, the fluorine side chains are present in a zigzag arrangement typical for alkanes and not a helical arrangement normally typical for fluorine side chains. The molecules are additionally grouped in hydrophilic and oleophobic segments. This can result in a better crystallinity of the fluorine side chains. In simplified terms, this means that the oleophobia of the systems can be increased due to the ionic structure of the fluorine groups. These effects enable the use of shorter fluorine chains with unchanged high oleophobic properties.

Further details and advantages of the invention result from the Figures and embodiments described in the following. There are shown in the Figures:

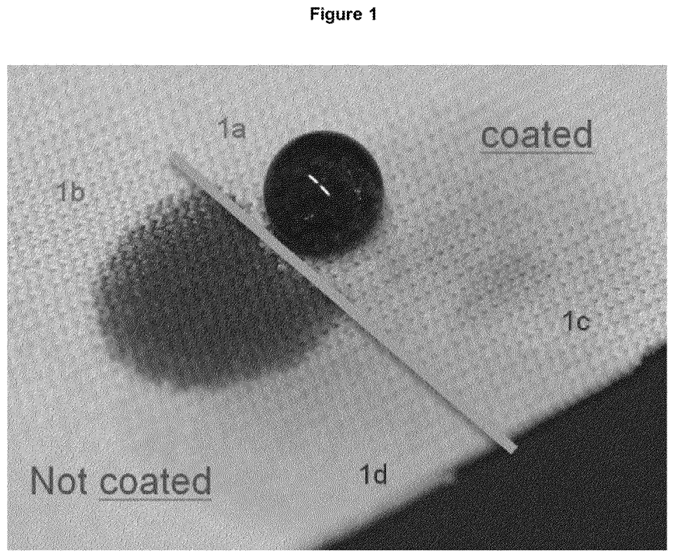

FIG. 1: a comparison of the behavior of uncoated substrates and substrates coated with an oleophobic polymer with respect to watery and oily phases; and

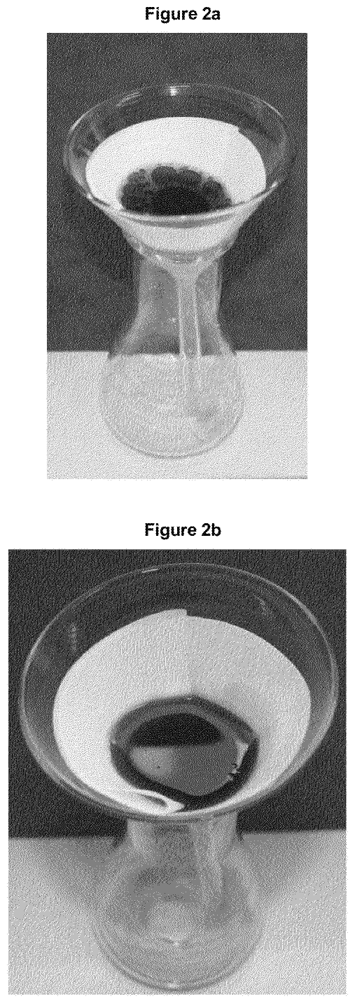

FIG. 2: an experimental design for separating a water/oil mixture using a filter in accordance with the invention.

FIG. 1 shows a textile of cotton fibers partially coated in a manner in accordance with the invention. The line divides the two halves, with the left half being uncoated and the right half being coated. Dots 1a and 1b each show sunflower oil that has been dyed red. The difference is clearly visible. In the coated region, an oil drop is formed having a contact angle considerably over 90°, while the drop is absorbed in the uncoated region. At the dots 1c and 1d, dyed drops of water have been applied to both sides and are absorbed by the textile in both cases. The recipe used is described in the following Example 6.

FIG. 2 shows a commercial filter of Macherey-Nagel coated in accordance with the invention. The filter used has the specification MN 616, an area density of 85 g/m², a thickness of 0.2 mm, and an average retention capacity of 4-12 μm. The filter was first wetted by a hexadecane dyed red for 1 minute. The hexadecane remained in the filter here and did not move through the filter, as is the case with a non-coated filter. Water dyed blue was subsequently added that moved through the filter without problem. FIG. 2a here shows how water and oil are separated in the filter after the addition of water. FIG. 2b shows how all the water moves through the filter and how the oil is retained. This image was taken after 2 hours. The recipe used will be described in the following Example 1.

### EXAMPLE 1

### Synthesis of a Hydrophilic and Oleophobic Membrane:

The substances shown in the following table were added to a flask and stirred for 5 minutes. A filter paper (MN616, see above) was subsequently wetted by this monomer mixture with the aid of a pipette. As part of the reproduction experiments, other methods were also additionally used such as the dipping process and the spray process.

| Quantity | |
|---|---|
| [mg] | Substance |
| 10 | 2,2-dimethoxy-2-phenylacetophenone |
| 100 | 3-(1H,1H,2H,2H-perfluorooctyl)-1-vinyl imidazolium |
| | iodide |
| 100 | 3,3′-(hexane-1,6-diyl)bis(1-vinyl |
| | imidazolium)dibromide |
| 125 | Acetonitrile |
| 125 | Propane-1-ol |
| 75 | Water |

The paper impregnated in this manner was then irradiated with the aid of a UV-LED lamp at a wavelength of approximately 365 nm for 3 minutes. The filter obtained was now slightly yellowed (iodine/triiodide) at the coated points. To examine the properties of the coating obtained more exactly, the contact angles of water and hexadecane were measured. Water here represents the hydrophilic component and hexane represents the hydrophobic component. Each value was measured 3 times and the mean value was noted.

### Results:

| | Contact angle |
|---|---|
| Drop used | after 5 seconds |
| Water [~4 μl] | Fully immersed |
| Hexadecane [~7 μl] | 123° (±2.5) |

The hexadecane drop remained unchanged as a drop on the filter paper for 2 minutes.

In addition, a separation of oil and water was carried out using the filter. The results are shown in Table 2.

### EXAMPLE 2

The recipe described in Example 1 was also applied to a commercially available paper tissue of Tork. It was likewise irradiated with a UV-LED lamp for 3 minutes. The coating obtained was likewise yellow. In the case of this substrate, the contact angle was additionally measured using diiodomethane.

| | Contact angle |
|---|---|
| Drop used | after 5 seconds |
| Water [~4 μl] | Fully immersed |
| n-hexadecane [~6 μl] | 115° (±4.5) |
| Diiodomethane [1.5 μl] | 124° (±1.5) |

### EXAMPLE 3

This example is very similar to Example 1; however, in this case, the still more hydrophilic chloride salt of the fluorinated cation was used. The same filter material and the same process materials were used as in Example 1.

| Quantity | |
|---|---|
| [mg] | Substance |
| 10 | 2,2-dimethoxy-2-phenylacetophenone |
| 100 | 3-(1H,1H,2H,2H-perfluorooctyl)-1-vinyl imidazolium |
| | chloride |
| 100 | 3,3′- |
| | (hexane-1,6-diyl)bis(1-vinyl imidazolium)dibromide |
| 125 | Acetonitrile |
| 125 | Propane-1-ol |
| 75 | Water |

Although the chloride salt of the fluorosurfactant has the much higher solubility, the water drop on the substrate was absorbed considerably more slowly. While the water drop in Example 1 was immersed below 5 seconds, it was now only observed after approximately 15 seconds. The contact angle of water measured directly at the start was 115° (±4.5).

| | Contact angle |
|---|---|
| Drop used | after 15 seconds |
| Water [~4 μl] | Fully immersed |
| n-hexadecane [~7 μl] | 115° (±3) |
| Diiodomethane [~1.5 μl] | 126° (±1.5) |

### EXAMPLE 4

The same recipe as in Example 3 was used to coat a cellulose fiber. A contact angle measurement was not possible exactly due to the many fibers that formed a very inhomogeneous surface since the values fluctuated too greatly. It was, however, possible to observe that water was absorbed after a few seconds while both hexadecane and diiodomethane remained on the cellulose fabric for at least 2 minutes. The following table shows the preparation of examples in accordance with the invention for the UV hardening of oleophobic and hydrophilic coatings:

| | Quantity [mg] | | | | | |
|---|---|---|---|---|---|---|
| Example | 5 | 6 | 7 | 8 | 9 | 10 |
| 2,2-dimethoxy-2-phenylacetophenone | 20 | 20 | 20 | 30 | 20 | 20 |
| 3-(1H,1H,2H,2H-perfluorooctyl)-2- | 200 | 200 | 100 | 100 | 100 | 100 |
| ((1H,1H,2H,2H-perfluorooctyl)thio)-1-vinyl | | | | | | |
| imidazolium chloride | | | | | | |
| Ethylene glycol dimethacrylate | 500 | | | | | 100 |
| Methanol | 500 | 500 | 300 | 300 | 300 | 300 |
| 3,3′-(hexane-1,6-diyl)bis(2-((1H,1H,2H,2H- | | 500 | | | | |
| perfluorooctyl)thio)-1-vinyl imidazolium) | | | | | | |
| dichloride | | | | | | |
| Trimethylpropane triacrylate | | | 100 | | | |
| Polyethyleneimine | | | | 100 | | |
| Tetraethylene glycol dimethacrylate | | | | | 100 | |
| Butyl methacrylate | | | | | | 100 |

A cotton textile and a stainless steel mesh were coated with the recipe from Example 5 and were each hardened with a UV lamp for 30 minutes. FIG. 1 shows a cotton textile partially coated with the recipe used.

A cotton textile was coated with the recipe from Example 6. The textile was subsequently hardened with a UV lamp for 30 minutes. The textile obtained had hydrophilic and oleophobic properties.

The recipe prepared in Example 7 was hardened with a UV lamp for 30 minutes and exhibited a special behavior. The recipe behaved as a hydrophilic and oleophobic coating on a cotton textile; in contrast, on a glass carrier, this recipe demonstrated hydrophobic and oleophobic properties in a remarkable manner. This shows that the separating effects can be adapted to the respective surface quality and texture.

Example 8 was likewise hardened with a UV lamp for 30 minutes and subsequently applied to a textile. It likewise exhibited hydrophilic and oleophobic properties.

Example 9 was applied as a textile coating; Example 10 was hardened as a monolith both on a textile and on a glass carrier with UV for 30 minutes. These recipes exhibited hydrophilic and oleophobic properties both on glass and on the textile.

### EXAMPLES 10 AND 11

Quantity [mg]
Example #

| | 10 | 11 |
|---|---|---|
| Azobisisobutyronitrile | 20 | 20 |
| (AIBN) | | |
| 3-(1H,1H,2H, | 300 | 300 |
| 2H-perfluorooctyl)- | | |
| 2-((1H,1H,2H,2H- | | |
| perfluorooctyl)thio)- | | |
| 1-vinyl imidazolium | | |
| chloride | | |
| Ethylene glycol | 500 | 500 |
| dimethacrylate | | |
| Methanol | 500 | 500 |
| Titanium dioxide | | 100 |
| nanoparticles | | |

A commercial polyurethane foam having a pore size distribution between 1 μm and 500 μm was wetted with the two recipes and was subsequently hardened in a glass vessel at 65° C. for 4 h. The membrane thus obtained that was still very flexible was hydrophilic and oleophobic and was suitable for separating water and olive oil. The foam was then washed multiple times with water and acetone. Water and oil were subsequently again successfully separated with the aid of the membrane.

### EXAMPLES 12, 13, AND 14

Quantity in mg
Example

| | 12 | 13 | 14 |
|---|---|---|---|
| Water | 100 | 100 | 100 |
| 3-(1H,1H,2H,2H- | 4 | 4 | 4 |
| perfluorooctyl)-1-vinyl | | | |
| imidazolium chloride | | | |
| 2-acrylamido-2- | 4 | | 4 |
| methylpropane sulfonic | | | |
| acid sodium salt 50% | | | |
| in water | | | |
| 2,2′-azobis(2- | 0.15 | 0.15 | 0.15 |
| methylpropionamidine)- | | | |
| dihydrochloride | | | |
| Sodium acrylate | | 1.5 | |
| 2-[(3,5- | | | 0.2 |
| dimethylpyrazolyl) | | | |
| carboxyamino]ethylmethacrylate | | | |

Water and the monomers were presented first in recipes 12, 13, and 14. The solution was subsequently vigorously mixed at 75° C. for 15 minutes and the azo radical starter was added. The solution was then held at 75° C. for 1 h at full stirring speed. The obtained depositable solid was removed with the aid of a centrifuge and the textile was wetted with the supernatant. The textile was subsequently dried at 80° C. for 3 minutes and subsequently fixed at 150° C. for 1 minutes. The textiles obtained were water-permeable and oil-repelling.

### EXAMPLE 15 PREPARATION OF POLYMER SOLUTIONS

Quantity in mg
Example #

| | 15 | 16 |
|---|---|---|
| Water | 100 | 100 |
| 3-(1H,1H,2H,2H-perfluorooctyl)-1-vinyl | 6 | 4 |
| imidazolium chloride | | |
| 2,2′-azobis(2-methylpropionamidine)- | 0.15 | 0.15 |
| dihydrochloride | | |
| Butyl acrylate | | 4 |

Water and the monomers were presented first in recipes 15, and 16. The solution was subsequently vigorously mixed at 75° C. for 15 minutes and the azo radical starter was added. The solution was then held at 75° C. for 1 h at full stirring speed. The stirring speed was subsequently carefully reduced and stirring was continued at a very low stirring speed for 2 h. A white solid was obtained in both experiments here. This solid exhibited a molar mass distribution of 60,000 Da to 450,000 Da.

The dried homopolymer from Example 15 was able to be dissolved at over 220 g/I in Novec HFE 7100 IPA (3M). The viscosity obtained was able to be set between 50 mPas and more than 5,000 mPas at 20° C. Both films and direct membranes or fibers can be produced in this viscosity range.

The copolymer from Example 16 was now also partially soluble in organic solvents due to the increased proportion of butylacrylate. The polymer was soluble over 20 g/I in DMAC and DMF. This solubility thus permits the integration in existing polymer membranes such as polysulfones, poly(vinylidene difluoride) or polyacrylonitrile. Through the selection of the copolymers and co-membrane polymers, a hydrophilic and oleophobic membrane can now be produced, for example, as a flat membrane or as a hollow fiber membrane.

1. A filter for separating hydrophilic and hydrophobic fluids, wherein the filter comprises the filter coated with an oleophobic polymer; and wherein the filter exhibits hydrophilic and oleophobic properties, and wherein
at least some of the repetitive units of the oleophobic polymer are based on a monomer that contains fluorine and that is an ionic organic molecule that has an ionic group, a crosslinkable group, and a group containing fluorine.

2. The filter in accordance with claim 1, wherein the filter is a porous filter layer.

3. The filter in accordance with claim 2, wherein the porous filter layer is a coated substrate.

4. The filter in accordance with claim 1, wherein the group containing fluorine is a perfluorinated carbon group.

5. The filter in accordance with claim 1, wherein the crosslinkable group comprises a reactive double bond.

6. The filter in accordance with claim 1, wherein the ionic group is an ionically charged heterocyclic and/or in that the charge is delocalized over a plurality of atoms of the ionic group.

7. The filter in accordance with claim 1, wherein the ionic group or the monomer containing fluorine is positively charged overall.

8. The filter in accordance with claim 1, wherein a spacer is arranged between the ionic group and the group containing fluorine and/or between the ionic group and the crosslinkable group.

9. The filter in accordance with claim 1, wherein the oleophobic polymer is a copolymer; and in that at least some other portions of the repetitive units are based on a hydrophilic comonomer that has a polymerizable group and a hydrophilic group.

10. The filter in accordance with claim 9, wherein the proportion of the repetitive units of the copolymer that are based on the monomer containing fluorine is between 0.1 and 50 mol %.

11. The filter in accordance with claim 9, wherein a further proportion of the repetitive units of the copolymer is based on a crosslinking comonomer that has at least two crosslinkable groups or at least one crosslinkable group and one reactive group.

12. A method of producing the filter of claim 1,
said method comprises the following steps:
providing a solution of the monomer containing fluorine and optionally of the further comonomers;
applying this solution to a substrate; and
crosslinking the monomers to form the polymer.

13. A method of producing the filter of claim 1,
said method comprises the following steps:
providing a solution of the oleophobic polymer and optionally of further polymer or monomer components;
applying this solution to a substrate; and
removing the solvent.

14. A method of producing a filter in accordance with claim 1,
said method comprises the following steps:
providing a solution of the oleophobic polymer and optionally of further polymer or monomer components;
precipitating or phase extruding with an antisolvent.

15. A method of separating hydrophilic and hydrophobic fluids utilizing the filter in accordance with claim 1.

16. The filter in accordance with claim 1, wherein the filter is a filter membrane.

17. The filter in accordance with claim 1, wherein the filter is a filter membrane having a filter layer, with a pore size of the filter layer being between 1 nm and 1 mm.

18. The filter in accordance with claim 1, wherein the filter is a filter membrane having a filter layer, with the pore size of the filter layer being between 10 nm and 0.5 mm.

19. The filter in accordance with claim 2, wherein the porous filter layer is a coated substrate, with the coated substrate comprising polytetrafluoroethylene, expanded polytetrafluoroethylene, polysulfone, polyether sulfone, polyethylene, polypropylene, polyester, polyurethane, polyvinylidene difluoride, polyamide, polystyrene, polyacrylonitrile, cellulose-based materials, a metal mesh, or combinations thereof.

20. The filter in accordance with claim 6, wherein the ionic group is an ionically charged heteroaromatic group.
